(19) United States
(12) Patent Application Publication
(10) Pub. No.: US 2007/0283797 A1
(43) Pub. Date: Dec. 13, 2007

(54) COMBINATION POLYGON-SHELLED AND ROUND-SHELLED DRUM

(76) Inventors: James Crawford, Ventura, CA (US); Darryl W. Johnson, Ventura, CA (US)

Correspondence Address: DARBY & DARBY P.C., P.O. BOX 770, Church Street Station, New York, NY, 10008-0770, US

(21) Appl. No.: 11/692,431

(22) Filed: Mar. 28, 2007

Related U.S. Application Data
(60) Provisional application No. 60/789,812, filed on Apr. 5, 2006.

(51) Int. Cl. G10D 13/02

(52) U.S. Cl. 84/411 R

(57) ABSTRACT

A drum has a polygonal shell section and a round shell section interconnected to one another to mutually define a resonant chamber. A drum head connects to the round shell section, such as by seating on a drum wall of optionally adjustable height. Acoustic properties of the drum are enhanced by the polygonal section, and can be further influenced by providing a bass port. The bass port can have an adjustable position relative to the resonant chamber to thereby influence the coupling of acoustic waves and their transmission through the bass port.

### CROSS-REFERENCE TO RELATED CASE

This application claims the benefit of priority under 35 U.S.C. Section 119(e) from U.S. Provisional Application Ser. No. 60/789,812, filed Apr. 5, 2006, entitled “Combination Polygon-Shelled And Round-Shelled Drum,” which is hereby incorporated by reference in its entirety.

### FIELD OF THE INVENTION

The present invention relates generally to a musical drum that has both polygon and round shell sections for the drum wall. More particularly, the present invention relates to a drum combining acoustical speaker cabinet technology with round drum shell technology to produce acoustically new generated sounds, with enhanced levels of tonality, volume and audibility, and a wider range of tunability in relation to desired usable pitch.

### BACKGROUND OF THE INVENTION

Musical drums typically produce an audible sound when struck by an object such as a drum stick. Further, musical drums typically have round shells whose diameters closely match the diameter of the struck head of the drum. However, the traditional design limits the available range of sound that can be produced from a drum.

The novel device of the present invention provides a greater acoustical quality through a merger of drum technology with speaker cabinet technology. That is, the drum combines the traditional round shell with a shell section having a polygonal cross section, similar to what is used for speaker cabinetry. The novel apparatus can provide a greater resonating volume within the drum than what is available with a traditional round shelled drum. In addition, the device provides a range of sounds not producible with a shell having a single cross-sectional geometry. That is, the invention provides improved tonality, especially in the bass frequencies, because of the combination of shell sections having different cross-sections. Drums of varying sizes and shapes, including bass, tom-tom, and others, can be made in accordance with the present invention.

### SUMMARY OF THE INVENTION

In a general aspect, the present invention concerns a drum having both a polygonal shell section and a round shell section interconnected to one another and defining a resonant chamber therein. A drum head connects to the round shell section.

The round shell section can include a drum wall and a rim, with the rim being shaped to mount the drum head. The drum wall communicates with and is part of the resonant chamber. The drum wall has a height that spaces the drum head and the first end of the polyhedron at a distance. That distance can be adjusted so as to influence a tonal quality produced by the drum.

In a further aspect of the invention, a bass port can be supported by the polygonal shell section to provide an acoustic wave vent from the resonant chamber to an exterior of the drum. The bass port can be an opening into the resonant chamber. The bass port can be disposed at a location near a corner of the polygonal shell section. The bass port can be positioned away from a direct acoustical path of the drum head.

In more particular aspects, the bass port can comprise a tube having an inlet for coupling an acoustic wave from within the resonant chamber and an outlet for communicating the acoustic wave to an exterior of the dram. When embodied as a tube, the tube can be movable relative to the polygonal shell section. Thus, the tube can be translatable between an extended position in which the inlet is proximate to the polygonal shell section and a retracted position in which the inlet is positioned toward a center of the resonant chamber. Also, the tube can be rotationally positionable so as to alter the effective aperture of the inlet. A seal can be provided within the resonant chamber that cooperates with the rotationally positionable tube so as to at least partially close the inlet. Also, the bass port can include a valve 280 suitable for opening and closing the outlet.

Further aspects, structural features, and advantages can be appreciated from the accompanying description of certain embodiments and the drawing figures thereof.

### BRIEF DESCRIPTION OF THE DRAWINGS

FIG. 1 is a perspective view of an embodiment of a drum in accordance with the present invention;

FIG. 2 is a plan view of one side of an embodiment of a drum in accordance with the present invention;

FIG. 3 is a a plan view of the top of an embodiment of a drum in accordance with the present invention;

FIG. 4 is a perspective view of an embodiment of a drum in accordance with the present invention, further showing an optional bass port or vent;

FIG. 5 is a plan view of one side of an embodiment of a drum in accordance with the present invention;

FIG. 6 is a plan view of the top of an embodiment of a drum in accordance with the present invention;

FIG. 7 is a perspective view of an embodiment of a drum in accordance with the present invention;

FIG. 8 is a perspective view of an embodiment of a drum in accordance with the present invention;

FIG. 9 is a plan view of one side of an embodiment of a drum in accordance with the present invention; and

FIGS. 10A and 10B are plan views of an embodiment of a drum further including an adjustable bass port in accordance with certain further aspects of the present invention

### DETAILED DESCRIPTION OF EMBODIMENTS

The detailed description set forth below in connection with the appended drawings is intended as a description of the presently-preferred embodiments of the invention and is not intended to represent the only forms in which the present invention may be constructed or utilized. The description sets forth the functions and the sequence of steps for constructing and operating the invention in connection with the illustrated embodiments. However, it is to be understood that the same or equivalent functions and sequences may be accomplished by different embodiments that are also intended to be encompassed within the spirit and scope of the invention.

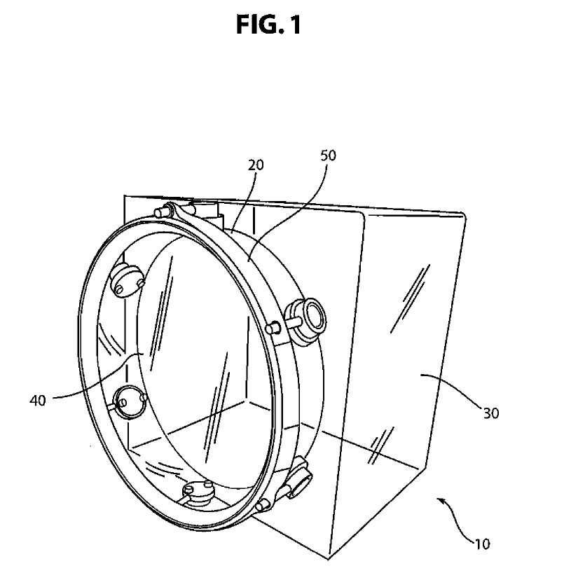

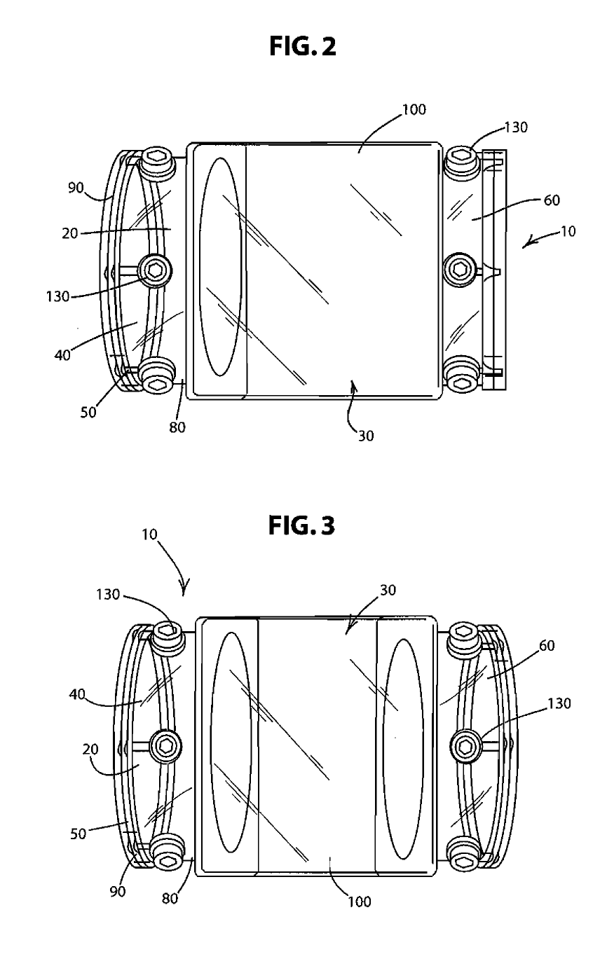

Referring to FIG. 1, the combination polygon-shelled and round-shelled drum 10 comprises a first round-shelled section 20, a polygon-shelled section 30, a drum head 40, and a means 50 for connecting the drum head 40 to the first round shelled section 20. In an embodiment of the invention as shown in FIGS. 2-10A and 10B, the drum 10 may further comprise a second round-shelled section 60. The polygon-shelled section 30 further comprises at least three flat sides, interconnected to form a polyhedron. The polyhedron forms the side walls of a resonating chamber having a first end and a second end. The first round-shelled section 20 is connected to the first end of the polygon-shelled section 30, while the second round-shelled section 60, if any, is connected to the second end of the polygon-shelled section 30.

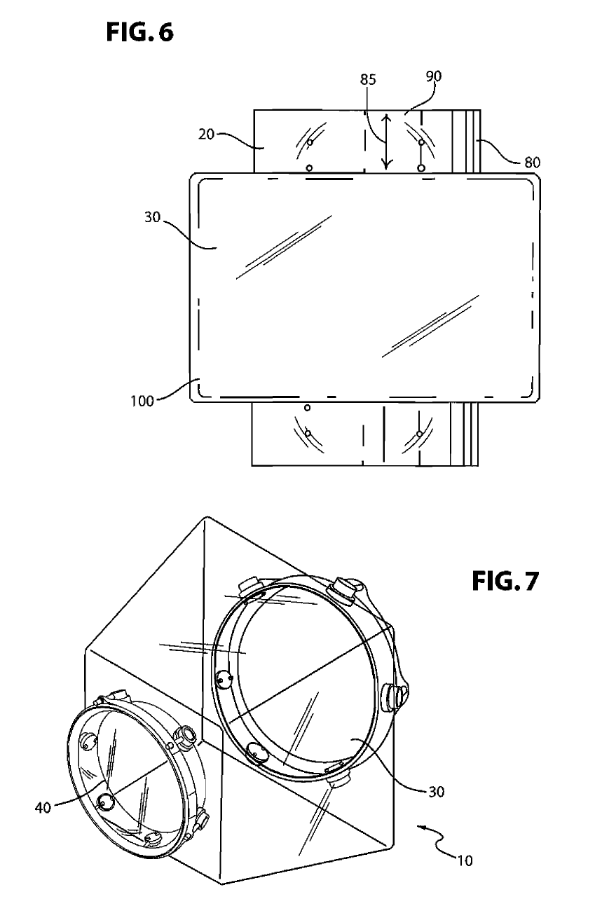

The first round-shelled section 20 may further comprise a cylindrical drum wall 80, having a rim 90. The rim 90 is shaped to accept the drum head 40. The drum head 40 may comprise a resonant membrane and may be of any shape, such as circular, oval, or otherwise. The height 85 (FIG. 6) of cylindrical drum wall 80 defines the distance between drum head 40 and the first end of the polygon-shelled section 30. Height 85 is preferably between 1 and 4 inches, however there is no upper limit. This ranges allows the round-shelled section 20 to adapt to standard industry hardware and mounting options. Having a height of at least 1 inch or greater gives the drum more sound options, a larger tonal-range and increased sustain and decay properties, enriching the drum in lower frequency tones and giving the drum a greater number of sound combinations. This provides for a desirable distortion to be made acoustically rather than electronically enhanced by an FX processor. Height 80 effects the sound output of the drum by increasing the internal space, mass and volume of the drum. Pitch or tone output by the drum is dependent on height 85. In one embodiment, the height and hence the distance between the drum head and the first end of the polyhedron is adjustable. Adjustments can be made by physically moving the drum wall or an adjacently mounted surface. Such movement can be by rotation (e.g., a threaded mounting of the drum wall) or by translation (e.g., a ratchet or selectively clamped slideable connection). The adjustment is preferably made by a movement that secures the drum head in a stable position suitable for drumming on the drum head, and preferably is air tight. By mounting the drum wall relative to the polygon-shelled section in a movable manner, more sound options result which enable the pitch and tone of the drum to be changed.

In the preferred embodiment, the drum head 40 is of a size and shape that is standard in the art. For example, drum heads are typically round and have a diameter between eight and forty inches, depending on the type of drum. Although the thickness of the cylindrical drum wall 80 can be any suitable dimension, in the preferred embodiment the width of the cylindrical drum wall 80 is between one quarter inch and one inch thick. Although the diameter of the rim 90 can be any suitable dimension, in the preferred embodiment the diameter is twelve inches. Other commonly used diameters might be between eight and forty inches. Further, although the bearing edge of the rim 90 (i.e. where the drum head 40 contacts the round-shelled section 20) can be any suitable angle, in the preferred embodiment the bearing edge angle is forty-five degrees. Although the height of the cylindrical drum wall 80 can be any suitable dimension, in the preferred embodiment that height is between two inches and four inches.

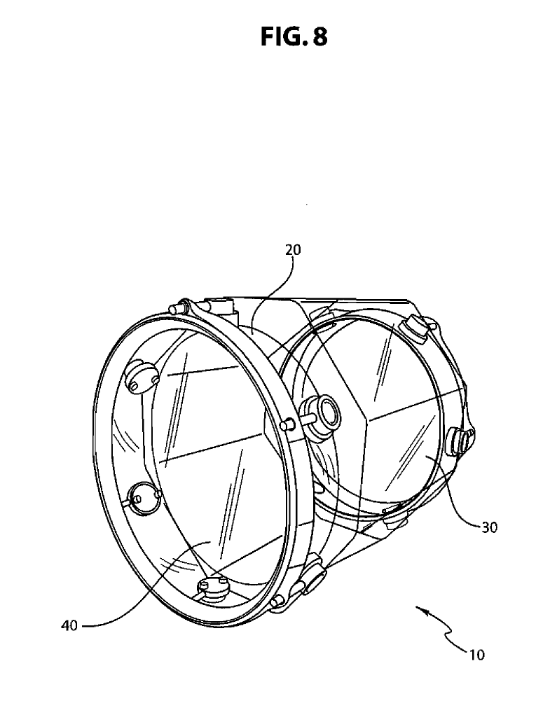

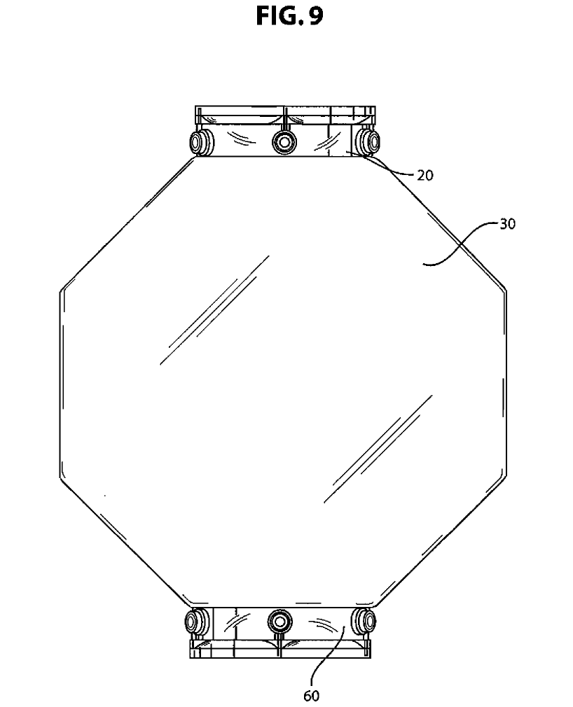

The polygon-shelled section 30 further comprises at least three flat sides 100, where the flat sides 100 are polygonal and are interconnected to form a polyhedron. The flat sides 100 can be of any polygonal shape, including the rectangular configuration depicted in FIGS. 1-6, the trapezoidal shape of FIG. 7, and the octagonal version as depicted in FIGS. 8-9. The polyhedron forms an at least partially enclosed resonating chamber, having a first end and a second end and having an interior and an exterior. The interconnections on the interior and on the exterior of the resonating chamber may be angular, or they may be arcuate. Further, the first end and the second end may define planes that are parallel to each other, or the planes may be nonparallel. In the preferred embodiment, there are four flat sides 100, which are rectangular and interconnect to form a hexahedron, where the first end and the second end are opposite each other and are essentially parallel to each other, as shown in FIG. 1. Referring to FIG. 2, one end which supports the first round-shelled section 20 is non parallel to its opposing wall. Referring to FIG. 3, both ends that support respective round-shelled sections 20 are non-parallel to one another. Although the wall thickness of the flat sides 100 can be any suitable dimension, in the preferred embodiment the wall thickness is between one quarter inch and one inch. Further, although the length of the flat sides 100 can be any suitable dimension, in the preferred embodiment the length is fourteen inches. Other commonly used lengths might be between ten and twenty inches or more.

The shape of the first end of the polygon-shelled section 30 is such that the geometry of the polygon-shelled section 30 blends with the circular geometry of the first round-shelled section 20. In the preferred embodiment, the first end is flat, has a wall thickness between one-quarter inch and one inch, and has a circular cutout that essentially matches the outer diameter of the cylindrical drum wall 80. The second end of the polygon-shelled section 30 may be left open, may be closed by a panel, or may be shaped such that the geometry of the polygon-shelled section 30 blends with the circular geometry of the second round.-shelled section 60, if any. For example, the blend can result in an uninterrupted resonant chamber, that is, a connection between the polygonal section and the round section with no lip or flange extending into the polyhedron resonant chamber.

The first round-shelled section 20 or the second round-shelled section 60 may be centered within the first end or second end, respectively, of the polygon-shelled section 30, as generally depicted by the figures. Otherwise, either or both may be off-centered. In embodiments including the second round-shelled section 60, its rim can be left open (i.e. without a drum head). Alternatively, its rim can be fitted with a drum head as with the first round-shelled section. If so, the second drum head can act as a non-struck, resonant head, or it can be a second struck head.

The ratio between the height of the first round-shelled section 20 or the second round-shelled section 60 and the height of the polygon-shelled section 30 varies in different embodiments of the invention. This variation permits different tonal qualities to be produced by the drum 10. In the preferred embodiment, the height of the polygon shelled section 30 is between two times and four times the height of the first round-shelled section 20 or the second round-shelled section 60. In the preferred embodiment, the height of the first round-shelled section 20 is equal to the height of the second round-shelled section 60.

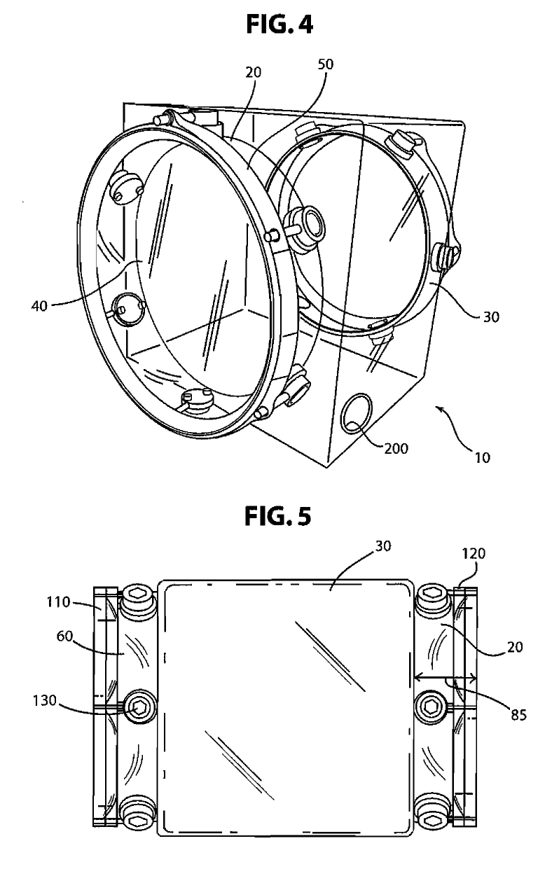

Referring again to FIG. 4, a drum having a polygon-shelled section 30 as previously described can include a bass port 200 in communication with the resonant chamber and an exterior of the drum so as to redirect inward pressure outward. A drum 10 provided with a bass port can supplement or assist in low-frequency acoustic wave venting from the drum. The bass port can comprise an opening into the resonant chamber, as shown in FIG. 4. Plural openings can be provided, such as at locations near the corners of the polygon-shelled section 30, on a single side of the polygon or on opposite sides (e.g., top and bottom). Preferably, the bass port is positioned so as to not be directly in line with the drum head so that the acoustic waves that it couples are those that fill the resonant chamber. Optionally, a microphone mount can be included for placement of a microphone at or within the bass port 200.

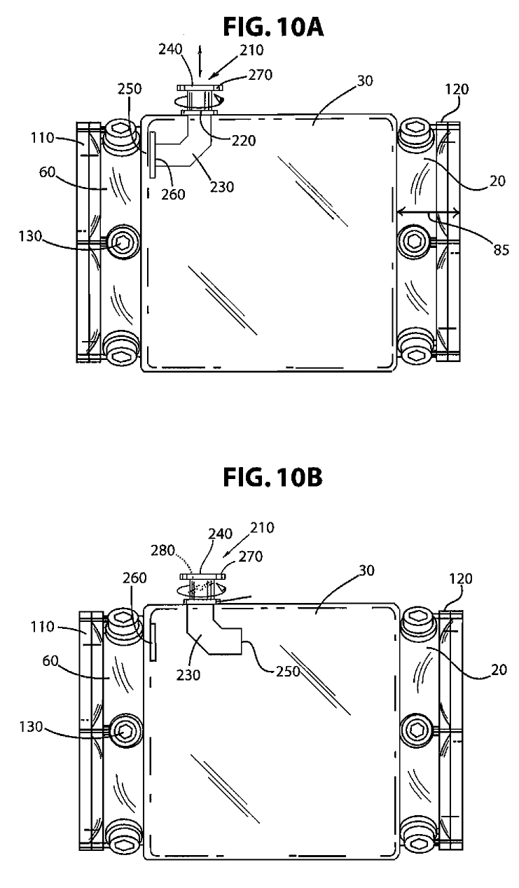

Referring now to FIGS. 10A and 10B, an adjustable bass port 210 can be provided in accordance with further aspects of the present invention. The bass port 210 includes a collar 220 seated in a fixed position upon a side panel of the polygon-shelled section 30, preferably so as to not be directly in line with the drum head so that the acoustic waves that it couples are those that fill the resonant chamber. A vent tube 230 is positioned within the collar 220, preferably such that it can be rotationally positioned, slideably positioned, or both (as shown). The tube 230 has an outlet 240 which permits pressure waves to vent from within the resonant chamber of the drum to the exterior. The tube 230 also has an inlet 250 which receives pressure waves from the resonant chamber for conveyance through the tube to the outlet 240.

In one embodiment, the inlet 250 is positionable relative to the interior walls of the polygon-shelled section 30 so as to reduce the size of or even completely close the inlet 250. In FIG. 10A, the inlet is oriented so as to be disposed against a surface 260, which optionally is made of a material which flexes to form a seal (e.g., a foam or rubber gasket) or which can have a shape that permits the outlet 240 to be rotated to and past it. In the orientation shown in FIG. 10A, pressure waves within the resonant chamber of the drum are not vented to the exterior. In the orientation shown in FIG. 10B, which is achieved by rotating the bass port 210, pressure waves within the resonant chamber of the drum are conveyed through the tube 230 to the outlet 240 so as to assist in the delivery of low-frequency waves.

In another embodiment, the inlet 250 is positionable so as to extend at various lengths toward the center of the resonant chamber. By translating the inlet 250 deeper into the polygon-shelled section 30, different acoustic waves are coupled at the inlet 250, which means that the sound emanating from the outlet 240 can be varied. In FIG. 10A, the inlet is fully positioned within the resonant chamber. In this position, a flange 270 abuts the collar 220 and prevents the bass port 210 from falling into the drum. Optionally, the inlet can be oriented over a range of rotatable positions, as described above, to couple less, more or different waves from within the resonant chamber. In FIG. 10B, the tube 230 has been partially retracted, such as by drawing the flange 270 outward, away from the polygon-shelled section 30. As a result, the inlet is positioned closer to the interior wall of the polygon-shelled section 30 and couples waves differently than when fully advanced into the chamber. Again, the inlet can be oriented over a range of rotatable positions, as desired, to couple and vent acoustic waves in a desired way.

In another embodiment, the tube 230 includes a valve 280 which can be manipulated in order to open or close the outlet 240, as well as to change the effective size of the outlet. The valve can be provided in addition structure suitable for enabling rotational and/or translational movement of the bass port 210, or can be provided instead of such structure.

In a variation of the foregoing, the inlet can have a shape selected to assist in the coupling of acoustic waves. As one non-limiting example, the inlet can have an opening cut at a 45° angle to its supporting structure. Thus, it can be cut 45° relative to the axis of the tube 230 that is adjacent to the inlet.

As will be appreciated by persons of ordinary skill in the art, a drum so-constructed to include the polygon-shelled section 30 in combination with a round-shelled section 20, with our without a bass port, can be used as a bass drum or as a rack Tom if placed on a stand.

The drum head connecting means 50 may comprise a fastening means such as a counter hoop 110 of the type known in the art, another type of mounting flange, or glue. Further, a counter hoop or a mounting flange may further comprise tension rods 120. The tension rods 120 may connect the counter hoop 110 or a mounting flange to jewelry hardware 130, or lugs, of the type known in the art and depicted in FIG. 1. Alternatively, the tension rods 120 may connect the counter hoop 110 or a mounting flange directly into the polygon-shelled portion of the drums 10. As an alternate using lugs, insert screws directly to the top and bottom perimeters can be used. The can be applied directly over the tension rods and a standard steel or die cast triple flanged mounting hoop.

In an embodiment of the invention, the drum 10 may further comprise a means for tuning the drum head 40. The drum head tuning means may comprise jewelry hardware 130 (i.e. lug and lug nut) of the type known in the art and depicted in FIG. 1, adjustment of the tension rods 120, or any other means for adjusting the tension of the drum head 40 while it is mounted on the rim 90.

In some embodiments of the invention, one or more of the flat sides 100 may have an additional round-shelled section. In such embodiments, those additional round-shelled sections may further comprise a drum head and a means for connecting the drum head to the additional round-shelled section, as described for the first round-shelled section 20.

In some embodiments of the invention, one drum head may be significantly smaller than another. In those embodiments, the flat sides 100 may be tapered toward the smaller drum head. An example of such an embodiment is depicted in FIG. 7. This tapering can produce unique acoustic effects similar to the pressure differential produced in a nozzle. That is, the acoustic wave produced at the striking drum head may be either diluted or concentrated as it travels through such a tapered cabinet, depending on the orientation of the tapering along the direction of the traveling acoustic wave. Of course, this tapering is equally contemplated for configurations containing two drum heads of substantially equal size. Additionally, this effect of diluting or concentrating the acoustic wave may equally occur in only a portion of the distance the wave travels through the cabinet space, such as where the tapering or beveling is limited to only a portion of the cabinet as illustrated in FIG. 9.

The drum 10 may be made of any suitable material, such as acrylic resin, wood, plastic, metal, glass, or laminated composites. If the drum includes transparent or translucent sections or partial sections, it can be illuminated from within. Although illumination within a drum is conventional, illumination of the polygon-shelled section provides a dramatic new visual effect. Optionally, such lighting can be modulated to change in time such as with the beat of ambient music or the beat of the drum itself.

Optionally, the resonant chamber can be pressurized or depressurized to change the pitch or tone output by the drum. One of the side walls of the polygon-shelled section can have an aperture and a tube having a first end extending from the aperture to provide a fluid path (e.g., air) into and out of the drum. A second end of the tube can be connected to an air source, for example, which can introduce or evacuate air from the resonant chamber of the drum and thereby alter its pitch or tone.

While the present invention has been described with regards to particular embodiments, it is recognized that additional variations of the present invention may be devised without departing from the inventive concept. In view of the above, it will be seen that several objects and advantages of the present invention have been achieved and other advantageous results have been obtained. It should be understood that any feature disclosed with respect to one embodiment of the invention can be equally applied to any other disclosed embodiment of the invention to yield additional benefits of the combined features.

Although this invention has been described with a certain degree of particularity, it is to be understood that the present disclosure has been made by way of example only and that numerous changes in the detailed construction and the combination and arrangement of parts may be resorted to without departing form the spirit and scope of the invention.

We claim:

1. A drum, comprising:
a polygonal shell section having interconnected sides and a first end and a second end that together define a polyhedron resonant chamber;
a first, round shell section interconnected to the first end of the polyhedron;
a drum head; and
means for connecting the drum head to the first, round shell section.

2. The drum of claim 1, further comprising a second round, shell section connected to the second end of the polyhedron.

3. The drum of claim 1, wherein the first round, shell section comprises a drum wall and a rim, the rim being shaped to mount the drum head, and the drum wall communicating with and being part of the polygonal resonant chamber.

4. The drum of claim 3, wherein the drum wall has a height that spaces the drum head and the first end of the polyhedron at a distance.

5. The drum of claim 3, wherein the drum head connecting means includes means for adjusting a tension in the drum head while mounted on the rim.

6. The drum of claim 1, wherein the distance is adjustable so as to influence a tonal quality produced by the drum.

7. The drum of claim 1, wherein the interconnected sides of the polygonal shell section join within the interior of the resonant chamber in arcuate connections.

8. The drum of claim 1, wherein the first and second ends are non-parallel to one another.

9. The drum of claim 1, wherein the first end of the polygonal section blends with the first, round shell section.

10. The drum of claim 1, wherein the first, round shell section is mounted off center relative to the polygonal section.

11. The drum of claim 1, further comprising a further, round shell section supported by one of the interconnected sides of the polygon shell section.

12. The drum of claim 1, wherein the interconnected sides include a taper toward one of the first and second ends, whereby the polygonal resonant chamber produces an acoustic wave in response to a strike on the drum head which is either diluted or concentrated as it travels through the tapered polyhedron.

13. The drum of claim 1, further including a tube having a first end in fluid communication with the resonant chamber and a second end connectable to a source of air.

14. The drum of claim 1, further comprising a bass port supported by the polygonal shell section and providing an acoustic wave vent from the resonant chamber to an exterior of the drum.

15. The drum of claim 14, wherein the bass port comprises an opening into the resonant chamber.

16. The drum of claim 15, wherein the bass port comprises at least one opening disposed at a location near a corner of the polygonal shell section.

17. The drum of claim 14, wherein the bass port is positioned away from a direct acoustical path of the drum head.

18. The drum of claim 14, further comprising a microphone mount at or within the bass port.

19. The drum of claim 14, wherein the bass port comprises a tube having an inlet for coupling an acoustic wave from within the resonant chamber and an outlet for communicating the acoustic wave to an exterior of the drum, wherein the tube is movable relative to the polygonal shell section.

20. The drum of claim 19, wherein the tube is translatable between an extended position in which the inlet is proximate to the polygonal shell section and a retracted position in which the inlet is positioned toward a center of the resonant chamber.

21. The drum of claim 19, wherein the tube is rotationally positionable so as to alter the effective aperture of the inlet.

22. The drum of claim 21, further comprising a seal within the resonant chamber which cooperates with the rotationally positionable tube so as to at least partially close the inlet.

23. The drum of claim 19, wherein the bass port includes a valve 280 suitable for opening and closing the outlet.
